(19) United States
(12) Patent Application Publication
(10) Pub. No.: US 2016/0154190 A1
(43) Pub. Date: Jun. 2, 2016

(54) DUPLEX FIBER OPTIC CONNECTOR PLUG

(71) Applicant: JYH ENG TECHNOLOGY CO., LTD., New Taipei City (TW)

(72) Inventor: YEN-LIN LIN, NEW TAIPEI CITY (TW)

(21) Appl. No.: 15/015,105

(22) Filed: Feb. 3, 2016

Related U.S. Application Data
(63) Continuation-in-part of application No. 14/306,195, filed on Jun. 16, 2014.

(30) Foreign Application Priority Data
Jan. 28, 2014 (TW) 103103105

(51) Int. Cl. G02B 6/38

(52) U.S. Cl. CPC G02B 6/3893; G02B 6/3825; G02B 6/3879

(57) ABSTRACT

A duplex fiber optic connector plug includes at least one fiber optic connector, a first casing, a second casing and a release lever. The release lever is axially coupled to a surface of the first casing and has an end coupled to a release bracket of the fiber optic connector to form a seesaw design. During operation, the release lever is compressed by the force of the finger, so that an end of the release lever is elevated, and the other end compresses the release bracket downward to release from a fiber optic socket, so as to provide an intuitively convenient operation and improve the convenience of use.

### CROSS-REFERENCE TO RELATED APPLICATIONS

This application is a continuation-in-part patent application of U.S. application Ser. No. 14/306,195 filed on Jun. 16, 2014, the entire contents of which are hereby incorporated by reference for which priority is claimed under 35 U.S.C. §120.

### BACKGROUND OF THE INVENTION

1. Field of the Invention

The present invention relates to the technical field of fiber optic connectors, and more particularly to a duplex fiber optic connector plug operated by an upward pushing method.

2. Description of the Related Art

Most traditional network communication technologies utilize copper wires as network jumping to connect different machine cabinets in a network engine room and a medium for transmitting data through an electric signal transmission method. As network technology advances and data volume becomes increasingly larger, the general electric signal transmission method no longer meets application requirements, so that data are transmitted by optical signals with a faster transmission rate, and such method is generally used for the connection in large engine rooms such as the connection between the telecommunication company's network and engine rooms of buildings in residential areas or office buildings.

Since the data volume of applications used in the network is getting greater and most data flow in the network engine room and they are transmitted between engine cabinets, therefore the data transmission method of the present existing copper network jumping fails to comply with application requirements, and present engine rooms gradually switch to fiber optic jumping for data transmission. Compared with the conventional copper network jumping, the fiber optic jumping has the following advantages: The number of fiber optic cables is greater than the number of copper network cables within the same diameter of the cables, and most fiber optic connectors are smaller than the conventional network connectors, so that more fiber optic connectors cannot be accommodated in the same high density mounting circumstance. In addition, the fiber optic connector is improved from the past relatively larger ST TYPE and FC TYPE to the present common LC connectors, and thus reducing the occupying space and increasing the capacity of accommodating the connectors in the machine rooms significantly.

For the same reasons, maintenance or construction technicians are unable to plug or unplug the fiber optic connectors by using fingers during construction and/or maintenance jobs. Sometimes, unplugging a fiber optical connector causes the unplugging of the adjacent ones, and it becomes an issue of unplugging the fiber optical connectors.

To overcome the aforementioned problem, the following two methods are generally used at present. 1. A clamping method is used to clamp and unplug the connector. 2. A fiber optic connector with a specially designed structure is adopted to facilitate the unplugging of the fiber optic connector. For example, an “Optical connector plug” disclosed in U.S. Pat. No. 7,588,373 comprises an upwardly and backwardly extended elastic bracket with a front side coupled to the rear side of a plug main body, and the middle section of the elastic bracket has a locking piece latched with a fiber optic adapter, and a flange is formed at a rear end of the elastic bracket, and a slider is coupled to a rear end of the plug, and a cam portion is formed at a front end of the slider and coupled to the flange. When the slider moves towards the rear end, the cam portion presses against the rear end of the elastic bracket to force the elastic bracket to move downwardly and approach the plug body, so that the locking piece in the middle section of the elastic bracket is separated from the fiber optic adapter, so as to unplug the fiber optic connector from the fiber optic adapter. In “Push-pull fiber optic connectors and methods for making the same” as disclosed in U.S. Pat. No. 8,152,384, a fiber optic connector plug comprises a plug main body coupled to a front end of the connector plug and upwardly and backwardly extended elastic bracket, and a locking piece is disposed in the middle section of the elastic bracket and latched with the fiber optic adapter. The fiber optic connector further comprises a sliding shroud on the plug main body, and the shroud has a decoupling member disposed on the shroud. When both of the shroud and the decoupling member slide backward simultaneously, the decoupling member forces the rear end of the elastic bracket to move downward, so that the locking piece in the middle section of the elastic bracket is separated from the fiber optic adapter, and the fiber optic connector is separated from the fiber optic adapter. Further, a “Plug connector having unlocking mechanism” disclosed in U.S. Pat. No. 8,221,007 comprises a front end coupled to a plug main body and an upwardly and backwardly extended elastic bracket, and the middle section of the elastic bracket has a locking piece latched with a fiber optic adapter, and both sides at the rear end of the elastic bracket have slanted surfaces, and the fiber optic connector plug further comprises a displacement element capable of moving with respect to the plug main body, and an unlocking element is formed at the front end and contacted with a slanted surface on both sides of the rear end of the elastic bracket. After the displacement element is moved with respect to the plug main body, the unlocking element forces the elastic bracket to move downward, so that the locking piece of the elastic bracket is detached from the fiber optic adapter. In a “Latching connector with remote release” as disclosed in U.S. Pat. No. 8,465,317, the latching connector comprises a plug main body coupled to a front end of the latching connector, and an elastic bracket upwardly and backwardly extended from a front end of the plug main body, and a locking piece is disposed in a middle section of the elastic bracket and latched with a fiber optic adapter, and an unlock structure is formed at a rear end of the elastic bracket, and a pull string is coupled to the unlock structure and pulled to force the elastic bracket to move downward, so that the locking piece of the elastic bracket is separated from the fiber optic adapter.

In the aforementioned conventional fiber optic connectors, modifications are made in the original designed fiber optic connector structure, so that these connectors cannot be used universally for the already installed fiber optic connectors, and it is necessary to change the connectors as required. Obviously, the conventional fiber optic connectors waste unnecessary labor to change the connectors, cause inconvenience in their use, and require further improvements.

### SUMMARY OF THE INVENTION

In view of the problems of the prior art, it is a primary objective of the present invention to provide a duplex fiber optic connector plug that combines a release lever with a first casing surface by an axial connection method to provide a seesaw design and releases the duplex fiber optic connector plug in an intuitively convenient manner, so as to improve the convenience of operation significantly. In addition, the release lever is combined with the first casing surface integrally or through a pivotal connection method to meet different application requirements.

To achieve the aforementioned and other objectives, the present invention provides a duplex fiber optic connector plug that is coupled to a fiber optic socket for a signal connection, and the duplex fiber optic connector plug comprises: at least one fiber optic connector, having a release bracket installed onto a surface of the fiber optic connector and obliquely and upwardly extended from a front end to the rear end of the fiber optic connector, and a locking piece disposed in a middle section of the release bracket for combining with the fiber optic socket; a first casing, coupled to a rear end of the fiber optic connector; a second casing, covered onto a side of the first casing, so that the fiber optic connector is fixed into the second casing; a release lever, having a middle section axially coupled to the top side of the second casing, a first contact surface formed at the front end of the release lever and coupled to the release bracket, and a rear end tilted upwardly to form a second contact surface; so that when the duplex fiber optic connector plug is plugged into the fiber optic socket, the locking piece disposed on the release bracket is latched and fixed into the fiber optic socket, and the second contact surface is moved upwardly by an external force, the release lever uses the pivotal connecting position as a fulcrum to drive the first contact surface to move downward and separate the locking piece of the release bracket from the fiber optic socket to define a release status.

In a preferred embodiment, the first casing is divided into a front section and a rear section to facilitate the operation of the fiber optic jumping, and the front and rear sections are connected by a flexural portion, and the front section is folded with respect to the rear section, and the front section has a slot, and the rear end of the fiber optic connector has a corresponding a latch portion for latching into the slot to define a fixation. Therefore, the fiber optic connectors can be switched without the need of separating the first casing and the second casing completely, so as to prevent missing the components after removal.

To improve the labor saving effect, the ratio of the distance between the distal portion of the first contact surface of the release lever and the axial connection position to the distance between the axial connection position and the distal portion of the second contact surface falls within a range form 1:2 to 1:5. The distal portion of the first contact surface has an inverted hook portion extended downwardly, and the distal portion of the release bracket has an abutting portion extended upwardly, such that the inverted hook portion and the abutting portion are latched to one another to prevent their being loosened during use.

In another preferred embodiment, the release lever may be integrated with the axial connection position of the first casing or the first casing has a first axial connection portion, and the release lever has a second axial connection portion, and a shaft is passed through the first axial connection portion and the second axial connection portion to define a movable axial connection status. Both of the aforementioned axial connection methods have the effects of improving the service life, lowering the manufacturing cost, providing different effects to meet the convenient application requirement, and enhancing the design flexibility significantly. In addition an elevated portion is formed at the bottom of the release lever and disposed between the axial connection position and the second contact surface for elevating the release lever to move the first contact surface downward. The first contact surface is a cambered surface which is concave downwards, so that the distal portion of the release bracket may be moved on the first contact surface to provide a smooth movement.

Wherein, the second contact surface is tilted upwardly with an angle between 10 degrees and 35 degrees, and the gap so formed allows the operator to insert the finger and guide the movement along the second contact surface.

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a cross-sectional view of a preferred embodiment of the present invention;

FIG. 4 is a first schematic view of an application of a preferred embodiment of the present invention;

FIG. 5 is a second schematic view of an application of a preferred embodiment of the present invention;

FIG. 6 is an another exploded view of a preferred embodiment of the present invention;

FIG. 7 is a third schematic view of an application of a preferred embodiment of the present invention;

FIG. 8 is a forth schematic view of an application of a preferred embodiment of the present invention; and

FIG. 9 is a fifth schematic view of an application of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

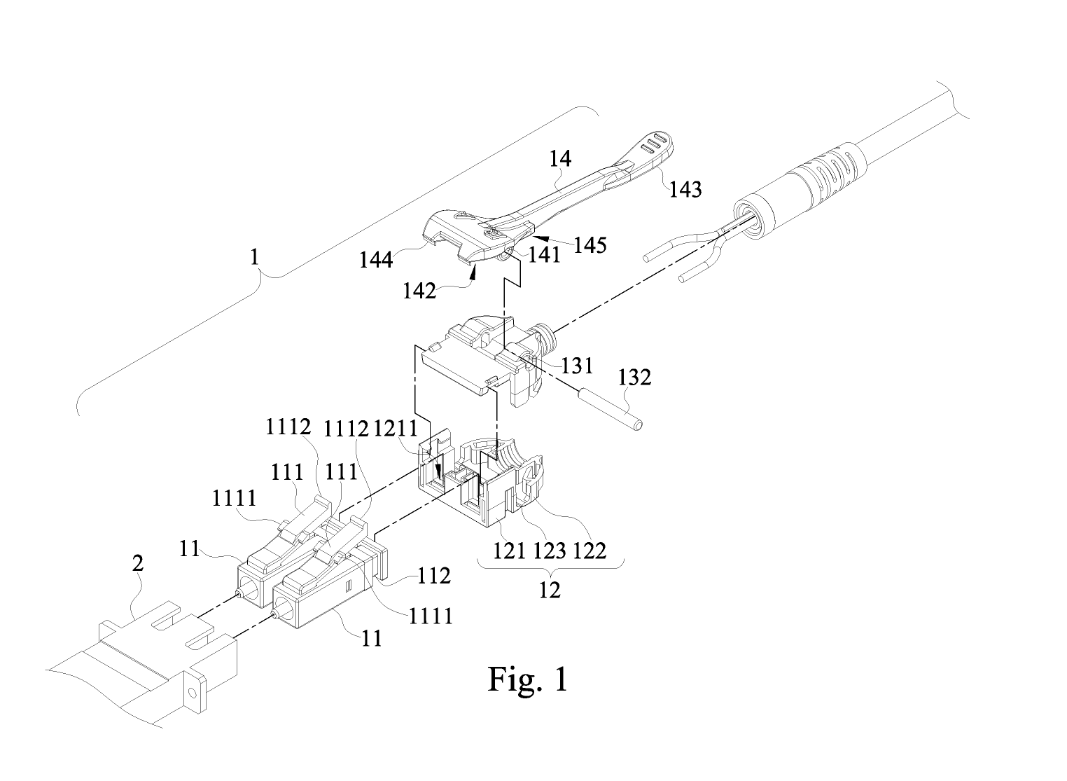

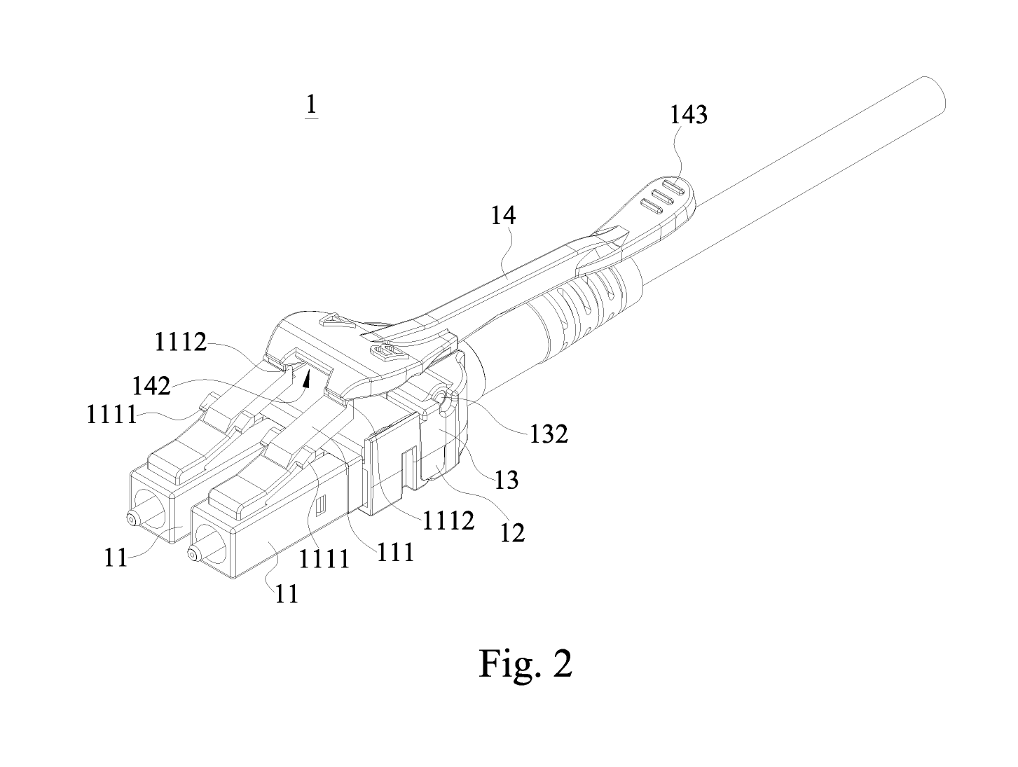

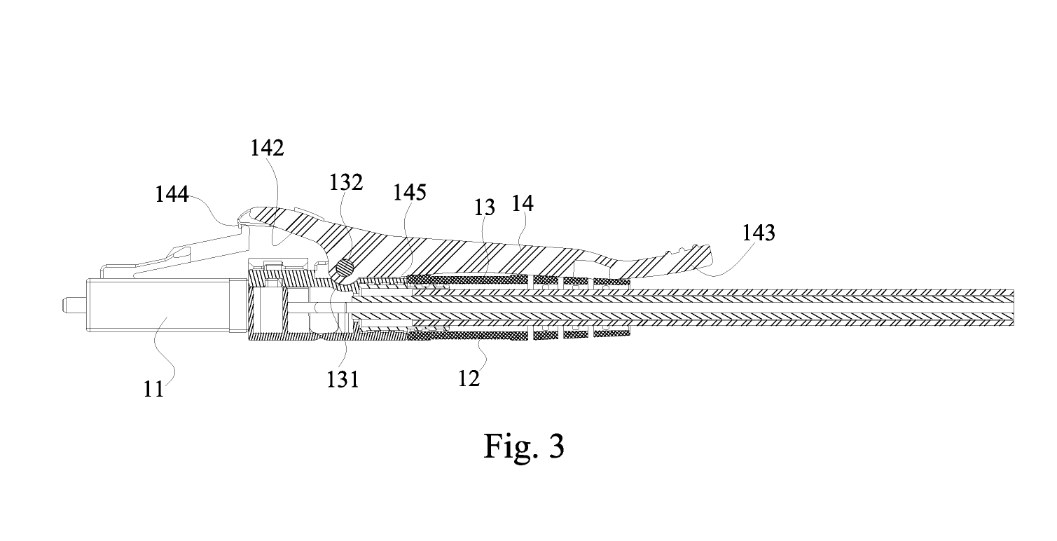

With reference to FIGS. 1 to 5 for an exploded view, a perspective view, a cross-sectional view and schematic views of a duplex fiber optic connector plug 1 in accordance with a preferred embodiment of the present invention respectively, the duplex fiber optic connector plug 1 is provided for connecting a fiber optic socket 2 to complete a signal connection, and the duplex fiber optic connector plug 1 comprises a pair of fiber optic connectors 11, a first casing 12, a second casing 13 and a release lever 14.

Each fiber optic connector 11 has a release bracket 111 installed on a surface of the fiber optic connector 11 and obliquely extended upwardly from the front end to the rear end of the fiber optic connector 11, and a locking piece 1111 disposed on both sides of the middle section of the release bracket 111 separately for coupling to the fiber optic socket. In addition, a latch portion 112 is disposed at a rear end of the fiber optic connector 11 and has a middle section in a necking H-shaped structure.

The first casing 12 is divided into a front section 121 and a rear section 122, and a flexural portion 123 is provided for connecting the front section 121 and the rear section 122, so that the front section 121 can be folded with respect to the rear section 122, and a slot 1211 is formed in the front section 121, and the latch portion 112 of the fiber optic connector 11 is latched into the slot 1211 to define a fixation, so that the first casing 12 is coupled to the rear end of the fiber optic connector 11.

The second casing 13 is covered onto the top side of the first casing 12 to fix the two fiber optic connectors 11 between the first casing 12 and the second casing 13 as shown in FIGS. 1-3, and a first axial connection portion 131 is disposed at the top the second casing 13.

A second axial connection portion 141 is disposed in the middle section of the release lever 14, and a shaft 132 is passed through the first axial connection portion 131 and the second axial connection portion 141 to define a movable axial connection status. In addition, a first contact surface 142 is disposed at a front end of the release lever 14 and coupled to a distal portion of the release bracket 111, and the rear end of the release lever 14 is tilted upwardly to form a second contact surface 143. Experiments show that the best and most labor saving effect can be achieved without interfering other adjacent duplex fiber optic connector plugs 1, if the ratio of the distance between the distal portion of the first contact surface 142 of the release lever 14 and the second axial connection portion 141 to the distance between the second axial connection portion 141 and a distal portion of the second contact surface 143 falls within a range from 1:2 to 1:5. In addition, an inverted hook portion 144 is extended downwardly from the distal portion of the first contact surface 142, and an abutting portion 1112 is extended upwardly from the distal portion of the release bracket 111, so that the inverted hook portion 144 and the abutting portion 1112 can be latched and contacted with each other without having any gap, so that the plug will not fall off easily during use.

In addition, an elevated portion 145 is formed at the bottom side of the release lever 14, and disposed between the axial connection position and the second contact surface 143 for elevating the release lever 14 in order to move the first contact surface 142 downward. Further, the first contact surface 142 is a cambered surface which is concave downwards, so that a distal portion of the release bracket 111 can be moved on the first contact surface 142, and an upwardly tilted angle of the second contact surface 143 falls within a range from 10 degrees to 35 degrees to facilitate the operation by the technician's fingers and guide the movement along the second contact surface 143. Further, the release lever 14 may be made by plastic injection molding and formed at the axial connection position of the first casing 12.

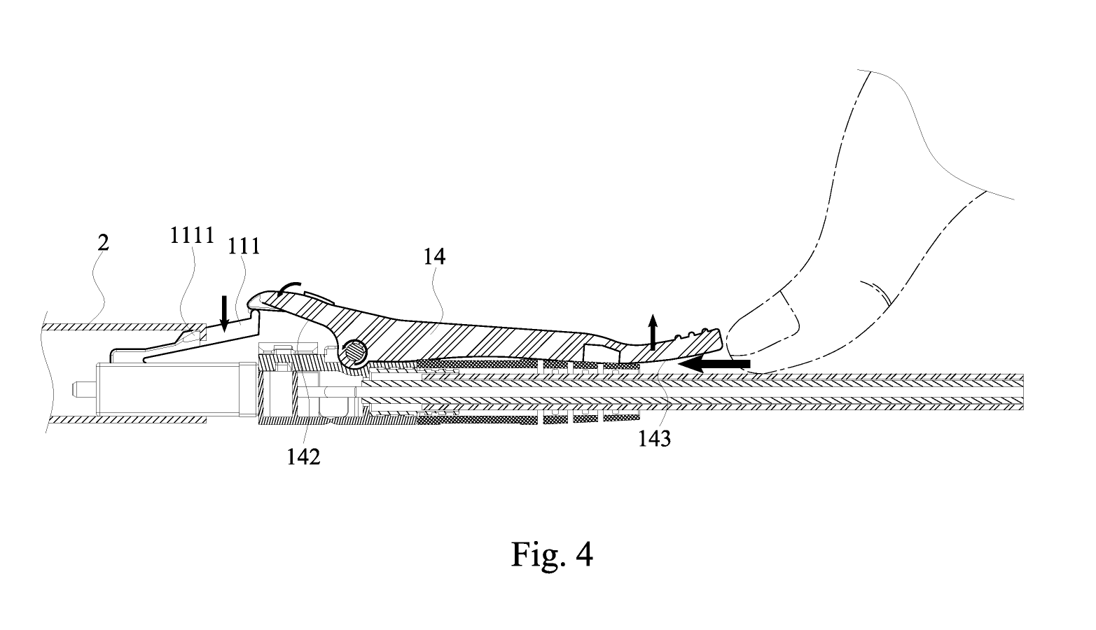

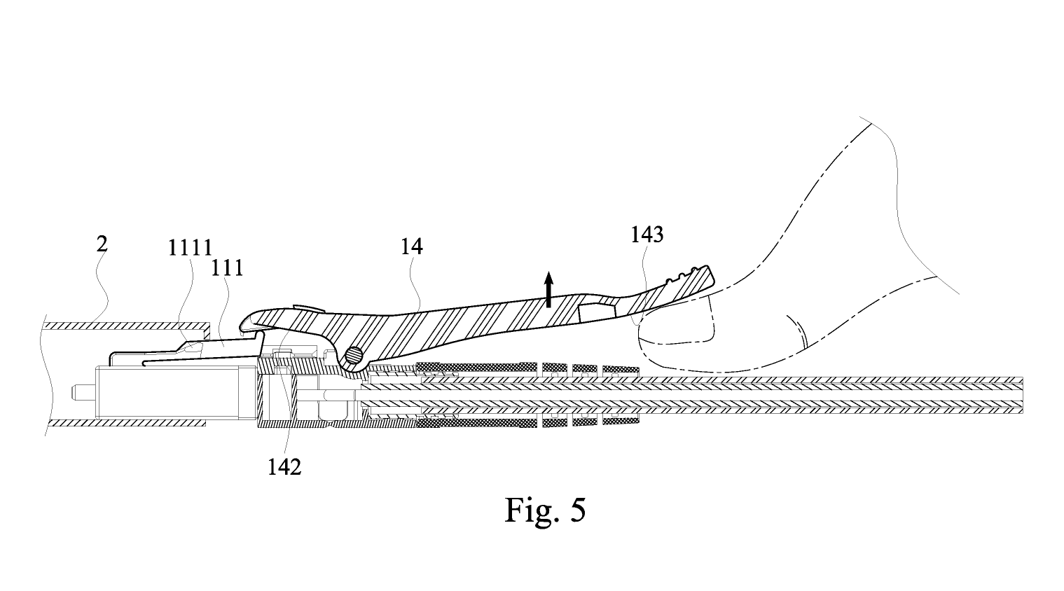

In FIGS. 4 and 5, when the duplex fiber optic connector plug 1 of the present invention is plugged into the fiber optic socket 2, the resilience of the release bracket 11 is provided to fix the related components after the locking pieces 1111 are passed through the fiber optic socket 2. When it is necessary to remove the duplex fiber optic connector plug 1, the operation simply passes a finger into a gap between the second contact surface 143 and the wire, so that the second contact surface 143 is pushed and moved upward by the compression force of the finger, and the release lever 14 uses that pivotal connection position as a fulcrum to drive the first contact surface 142 to move upward, so as to press and separate the release bracket 11 from the fiber optic socket 2 to define a release status, and the duplex fiber optic connector plug 1 can be removed quickly after the wire and the duplex fiber optic connector plug 1 are pulled.

Since the duplex fiber optic connector plug 1 of the present invention has two fiber optic connectors 11, a fiber optic jumping operation can be achieved, or the two can be switched for the operation. In particular, the first casing 12 is divided into the front section 121 and the rear section 122, and the flexural portion 123 is provided for connecting the front section 121 and the rear section 122, and the flexural portion 123. During operation, the front section 121 may be folded with respect to the rear section 122, so that the rear section 122 maintains its condition of latching with the second casing 13, and the two fiber optic connectors 11 can be switched for the operation without the need of separating the first casing 12 and the second casing 13 completely. The present invention not just provides a convenient operation, but also prevents the removed components from missing.

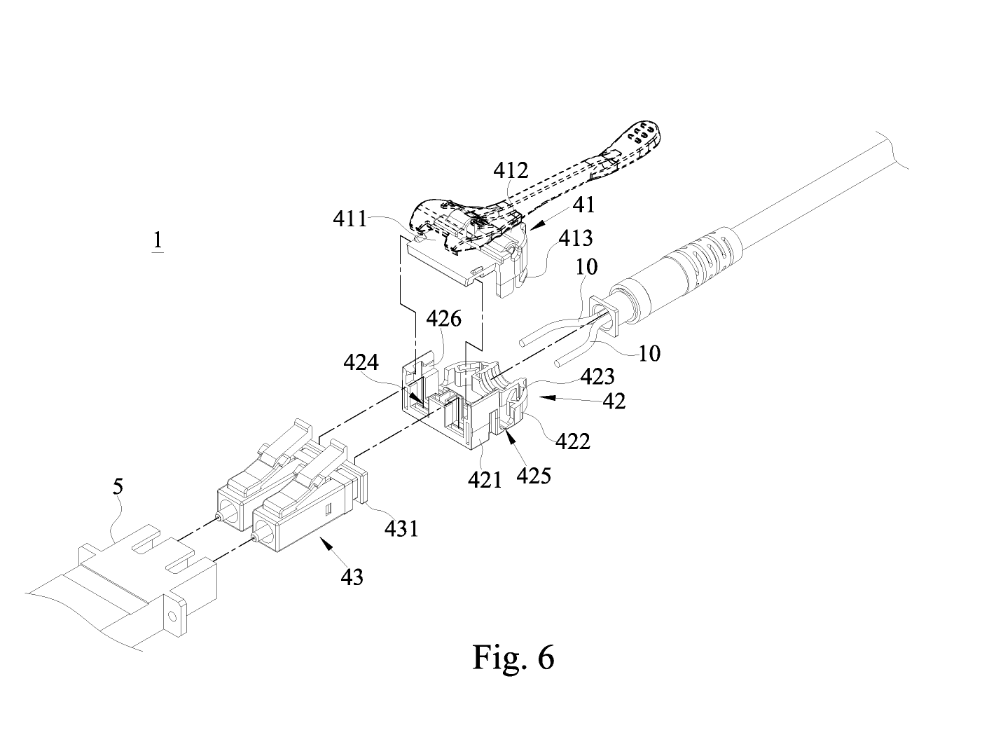

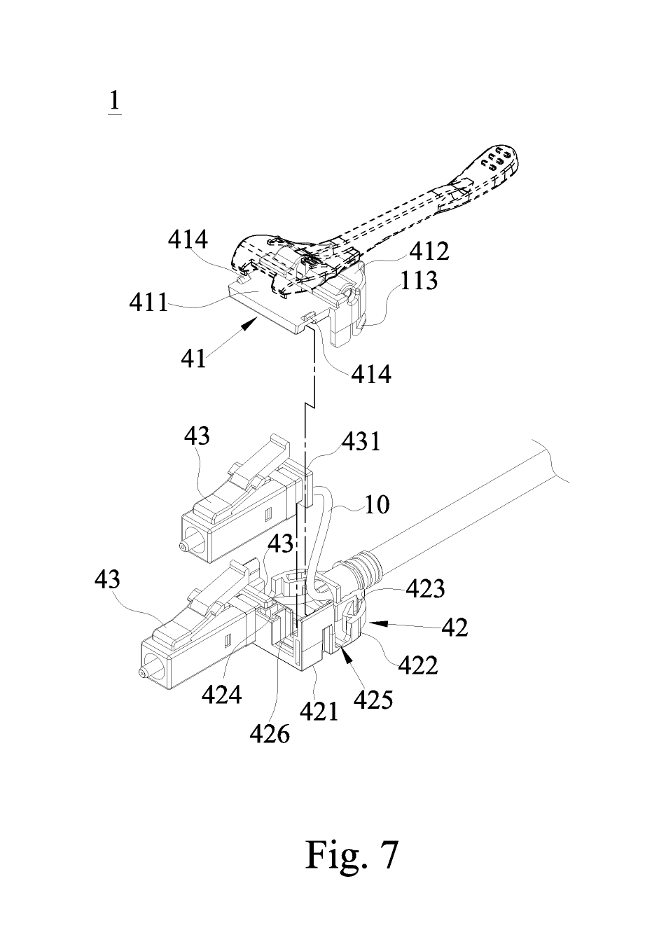

Please refer to FIGS. 6 and 7 for another embodiment of the resent invention. The duplex fiber optic connector plug 1 of the present invention is provided for connecting to a fiber optic socket 5, and comprises a cable line 10, a first casing 41, a second casing 42, and a pair of fiber optic connector 43.

In particular, the first casing 41 is divided into a first front section 411 and a first rear section 412. Both sides of the first front section 411 have a positioning bump 414, and both sides of the first rear section 412 are provided with a first latch hook 413 respectively. The first front section 411 is a sheet-like structure. The cable line 10 is installed at an end of the duplex fiber optic connector plug and can be a low friction cable line. When a user' s finger is inserted between the release lever 14 and the cable line 10 (as shown in FIG. 5), the finger is slipped in between the release lever 14 and the cable line 10 easily.

The second casing 42 is also divided into a second front section 421 and a second rear section 422. Both sides of the second rear section 422 are provided with a second latch slot 423 corresponding to the first latch hooks 413. The first latch hooks 413 are latched and fixed in the second latch slots 423 so that the first rear section 412 and the second rear section 422 form a single body. The inside of the second front section 421 have a pair of positioning slots 424. And a connecting segment 425 is provided between the second front section 421 and the second rear section 422. Both sides of the second front section 421 are provided with a second latch hook 426. And the second latch hooks 426 are covered and latch to the first rear section 411 to create fixture. It is worth mentioning that the connecting segment 425 is formed by injection molding onto the surface of the second casing 42 such that the longitudinal direction of the connecting segment is perpendicular to longitudinal direction of the fiber optic connector 43. The thickness of the connecting segment 425 is 0.5-0.8 times of the second casing 42. The thickness of the connecting segment is specially designed to prevent damage and breakage of the connecting segment, such that the bent angle of the connecting segment is 0-165 degrees. And a ratio between a distance from the connecting segment 425 to the second front section 421 and a distance from the connecting segment 425 to the second rear end 422 is 1:2-1:5.

The surface of every fiber optic connector 43 has a positioning element 431 which can be latched to the positioning slot 424. When each of the fiber optic connectors 43 is latched to the positioning slots 424 respectively, the positioning of the first casing 41 and the second casing 42 is achieved by latching the positioning bump 414 on both sides of a first front section 411 of the first casing 41 to the positioning slots 424 of the second casing 42. And each of the of the fiber optic connectors 43 has a fiber optic line contained therein.

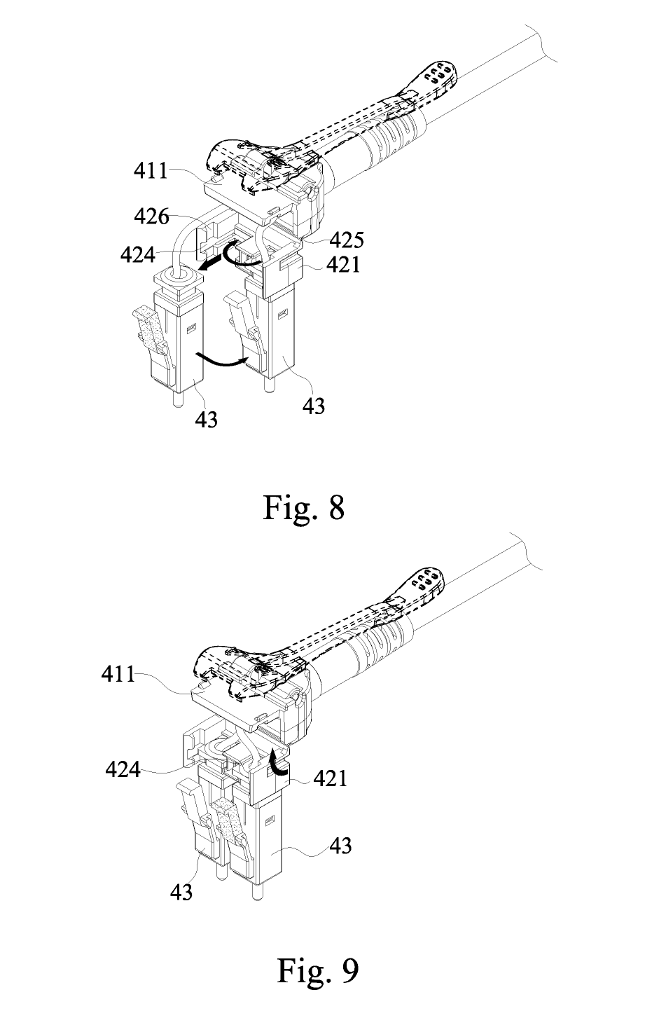

Please refer to FIGS. 7 and 8 for illustration of the maintenance operation of the present invention. First, unclip the second latch hooks 426 to separate the second front section 421 and the first front section 411; at this stage, the first rear section 412 and the second rear section 422 are still fixed to the first latch hooks 413 and the second latch slots 423. And then the second front segment is bent downward, using the connecting segment 425 as an axis, such that the fiber optic connectors 43 are exposed for easy access and removal. Lastly, the optical fiber connectors 43 are removed, switched position and placed back to the positioning slot 424. And then, the second front segment 421 is latched back to the first front segment 411 to finish maintenance operation. The present invention enables fast and easy cable line maintenance and is convenient for maintenance personnel to operate.

What is claimed is:

1. A duplex fiber optic connector plug, for coupling a fiber optic socket to complete a signal connection, comprising:
at least one fiber optic connector, having a release bracket installed on a surface of the fiber optic connector and extended obliquely and upwardly from a front end to a rear end of the release bracket, and the release bracket middle section having a locking piece for combining the fiber optic socket;
a first casing, coupled to a rear end of the fiber optic connector, the rear end being provided with at least one first latch hook;
a second casing, covered onto a side of the first casing for fixing the fiber optic connector therein, a rear end of the second casing being provided with at least one second latch hook corresponsive to the first latch hook to fix to a rear end of the first casing, an interior of the second casing having at least a pair of positioning slots, a connecting segment being provided between a front end and the rear end of the second casing, and the front end of the second casing being provided with at least one second latch hook to fix to a front end of the first casing to form a coupling;
at least a pair of fiber optic connectors, a surface of each of the fiber optic connectors having a positioning element for snapping the fiber optic connectors to the positioning slots, and each of the fiber optic connectors having a fiber optic, wherein during operation, the front end of the second casing separate from the front end of the first casing, the front end of the second casing can be fold via the connecting segment; and
a release lever, with a middle section axially coupled to the top side of the second casing, and having a first contact surface disposed at a front end of the release lever and contacted with the release bracket, and the rear end of the release lever being tilted upwardly to form a second contact surface, so that when duplex fiber optic connector plug is plugged into the fiber optic socket, the locking piece of the release bracket is latched and fixed into the fiber optic socket, and after the second contact surface is pushed by a force to move upward, the release lever uses the pivotal connection position as a fulcrum to drive the first contact surface to move downward, so that the locking piece of the release bracket is separated from the fiber optic socket to define a release status.

2. The duplex fiber optic connector plug of claim 1, wherein the ratio of the distance between a distal portion of the first contact surface of the release lever and the axial connection position to the distance between the axial connection position and a distal portion of the second contact surface falls within a range from 1:2 to 1:5.

3. The duplex fiber optic connector plug of claim 1, wherein the distal portion of the first contact surface has an inverted hook portion extended downwardly, and the distal portion of the release bracket has an abutting portion extended upwardly, so that the inverted hook portion and the abutting portion may be latched with each other.

4. The duplex fiber optic connector plug of claim 1, wherein the release lever is integrally formed with the axial connection position of the first casing.

5. The duplex fiber optic connector plug of claim 1, wherein the first casing has a first axial connection portion, and the release lever has a second axial connection portion, and a shaft is passed through the first axial connection portion and the second axial connection portion to define a movable axial connection status.

6. The duplex fiber optic connector plug of claim 4, wherein the release lever has an elevated portion formed at the bottom of the release lever and disposed between the axial connection position and the second contact surface for elevating the release lever to move the first contact surface downward.

7. The duplex fiber optic connector plug of claim 5, wherein the release lever has an elevated portion formed at the bottom of the release lever and disposed between the axial connection position and the second contact surface for elevating the release lever to move the first contact surface downward.

8. The duplex fiber optic connector plug of claim 1, wherein the first contact surface is cambered surface which is concave downwards, so that the distal portion of the release bracket may be moved on the first contact surface.

9. The duplex fiber optic connector plug of claim 1, wherein the second contact surface has an upwardly tilted angle falling within a range from 10 degrees to 35 degrees.

10. The duplex fiber optic connector plug of claim 1, wherein a thickness of the connecting segment is 0.5-0.8 times of a thickness of the second casing, a ratio between a distance from the connecting segment to the front end of the second casing and a distance from the connecting segment to the rear end of the second casing is 1:2-1:5.

11. The duplex fiber optic connector plug of claim 1, further comprising a low friction cable line installed at an end of the duplex fiber optic connector plug.

12. The duplex fiber optic connector plug of claim 1, wherein both sides of the first casing comprise a positioning bump, and the positioning bump is latched to the positioning slots such that the first casing and the second casing can be positioned relative to each other.
